(19) United States
(12) Patent Application Publication
(10) Pub. No.: US 2008/0089519 A1
(43) Pub. Date: Apr. 17, 2008

(54) Secure key exchange algorithm for wireless protocols

(75) Inventor: Jan-Erik Ekberg, Vantaa (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/548,812

(22) Filed: Oct. 12, 2006

(51) Int. Cl. H04L 9/00; H04K 1/00

(52) U.S. Cl. 380/270; 380/44; 380/274

(57) ABSTRACT

A system for establishing encryption keys in a manner suitable for linking low complexity and/or power constrained wireless devices. The present invention uses a combination of encryption algorithms and events, possibly including user manual intervention, to create a randomized encryption key that is substantially more difficult for a third party device to decipher than present automated algorithms currently in use. A user may randomly trigger, through a key press, information to be sent from a sending device to a receiving device which is used to establish an encryption key.

### BACKGROUND OF INVENTION

1. Field of Invention

The present invention relates to securing communication in a wireless protocol, and more specifically, to a system for propagating encryption keys to devices communicating over a wireless protocol suitable for low complexity and/or power constrained wireless devices.

2. Description of Prior Art

More and more, the ability to communicate wirelessly is emerging as a popular feature to include in many devices where communication was previously not contemplated. This popularity may, at least in part, be fueled by rapid technological development in the area of multifunction wireless communication devices (WCD). Consumers may now replace common standalone productivity devices like computers, laptops, facsimile machines, personal digital assistants, etc. with a single device capable of performing all of these functions. Devices with these abilities have been embraced by business people who often find that work can now be completed during time that was previously wasted (commutes to and from work, home, etc.)

However, while a WCD may be empowered with many beneficial features, the small size and power constraints of these devices may also create a hindrance for the user. The operator interfaces installed in these devices are often small, and not conducive to high throughput. As a result, users must rely on peripheral input devices such as keyboards, mice, headsets, etc. in order to perform their work. Further, the small size of many devices today also implies that there is a lack of physical connections to connect wired devices. Therefore, a WCD must not only be able to support wireless communications with a peripheral device, it must also be able to support connections with multiple peripheral devices being operated concurrently.

As more and more common devices include electronic control, there may also be a benefit in coupling these devices to a WCD, or possibly other “intelligent” mechanisms. For example, it may be desirable to wirelessly link two or more low power devices in a beneficial relationship, such as linking a wristwatch including health-monitoring intelligence to various wireless sensors placed on a user's body. Simpler communication protocols with lower power requirements are now being developed so that even devices that have not historically been “computerized” may now provide wireless information to, and in some cases receive wireless information from, a WCD. These devices must often run on battery power, and as a result, must rely on simple, power efficient communications in order to be functional. Most of the existing wireless communication protocols are either too simple or too complex to make these newly computerized applications workable. For example, radio frequency (RF) communication is efficient and may be powered by a scanning device, however, currently available RF transponder chips are space-limited and usually only provide information. On the other hand, IEEE 802.11x WLAN or “WiFi” is a commonly available and widely accepted wireless solution. However, the power requirements for WLAN may not make it appropriate for small device installations. Bluetooth™ is another short-range wireless protocol that is often used for linking peripheral devices to a WCD. The Bluetooth™ standard was originally designed to replace wires with a wireless medium for simple peripheral input devices. While, Bluetooth™ has now evolved much further than linking headsets and mice, it still may not be the best solution for extremely resource constrained wireless devices, as will be explored further below.

Further, the limitations of current wireless protocols become especially evident when trying to establish a security strategy for the aforementioned types of low complexity and/or power constrained wireless devices. Current security theories may often be too complex for simple devices in terms of required processing power and interface availability. These devices, such as remote wireless sensors, often have minimal onboard processing capabilities limited to information collection and transmission, limited overhead available for additional hardware integrated security solutions, and minimal user interface options provided for allowing a user, for example, to turn on a device and recognize it is operating through an LED, etc.

While these limitations exist, information conveyed between devices may be sensitive or confidential, and as a result, must be secure in order for the system to be practical. What is therefore needed is a system for securing information in a wireless communication protocol that is simple to implement for low complexity devices and efficient in power consumption. The system should allow a device to be linked by encryption keys in a manner that prevents other users, possibly with malicious intent, from obtaining the key information.

### SUMMARY OF INVENTION

The present invention includes at least a method, device and computer program for establishing encryption keys in a manner suitable for linking low complexity and/or power constrained wireless devices. The present invention uses a combination of encryption algorithms and timed events, possibly including user manual intervention, to create a randomized encryption key that is substantially more difficult for a third party device to decipher than present automated algorithms currently in use.

In at least one example of the present invention as recited above, a WCD needs only a button and some sort of simple visual or audible indicator in order to establish encryption keys. Randomized key and key_trans information is generated in a transmitter or sending device. This key and key_trans information may be divided into subparts, encrypted and then reformulated into information resembling standard communication protocol address information. These key information-based addresses may be accumulated while each device randomly changes its address information. At a time designated by a key or button press in one or both devices, the sending device may replace the current randomized address with an address containing at least a subpart of the key information and one or more subparts of the key_trans information, this address being further communicated to a receiver or receiving device. In this way, the receiving device may be informed that the received address is a subpart of the encryption key.

This process may continue over time with a user pressing keys on both the sending device and receiving device in order to wirelessly convey subparts of the key information. In parallel, both devices convey random data at random intervals that is similarly structured as the key subparts. At the conclusion of the process, a key, or possibly a set of keys (if there were many possible subpart packets visible at the time the button was pressed) may be compiled on the receiving device from the various subparts received. The set of keys are individually checked against the pattern by using some cryptographic function to ascertain which key of the key set is the right one. This key, a derivation of it, or a key conveyed in some other means in the subpart packets may be used to conduct secured transactions with the sending device. Further, the button presses (after the first one) may be replaced by a timing sequence based on a pin number or a password that is known to both the sending and receiving device. For example, the PIN may be hard-coded in the sending device. A user may then manually enter this pin in the receiving device.

Further, the transmitting device or transmitter may contain a microchip or chipset enabled to perform at least parts of the function of the invention. The parts of the function may be either stored as software instruction that are performed by the microchip or chipset, or the parts of the function may be hard-coded in the chip or chipset. Similarly, the receiving device or receiver may contain a microchip or chipset enabled to perform at least parts of the function of the invention. The parts of the function may be either stored as software instruction that are performed by the microchip or chipset, or the parts of the function may be hard-coded in the chip or chipset. It is also possible to have a microchip or chipset that performs at least parts of the function of both the transmitter and receiver.

The aforementioned timed events, for example button or key presses on a WCD, may be received at the microchip or chipset in form of electrical triggers (e.g., a high voltage or a rising edge of a voltage). The timed events may also be mapped to a timed sequence of messages or packets that are cast in a fixed timing framework, for example, of timeslots in a TDD or TDMA system. The timed sequence may be agreed between the devices beforehand.

### DESCRIPTION OF DRAWINGS

The invention will be further understood from the following detailed description of a preferred embodiment, taken in conjunction with appended drawings, in which:

FIG. 1A discloses a modular description of an exemplary wireless communication device usable with at least one embodiment of the present invention.

FIG. 1B discloses an exemplary structural description of the wireless communication device previously described in FIG. 1A.

FIG. 2 discloses an exemplary Bluetooth™ protocol stack and an exemplary Wibree™ protocol stack usable with at least one embodiment of the present invention.

FIG. 3A discloses an example of multiple wireless peripheral devices attempting to communicate concurrently with a dual-mode radio modem in accordance with at least one embodiment of the present invention.

FIG. 3B discloses further detail pertaining to the example of FIG. 3A regarding operational enhancements for managing the operation of a dual-mode modem in accordance with at least one embodiment of the present invention.

FIG. 4 discloses a more detailed example of a Wibree™ protocol stack in accordance with at least one embodiment of the present invention.

FIG. 5A discloses examples of encryption key establishment strategies usable with at least one embodiment of the present invention.

FIG. 5B discloses exemplary factors to consider in key establishment strategies for low complexity and/or power constrained wireless devices in accordance with at least one embodiment of the present invention.

FIG. 6 discloses an exemplary hardware implementation in accordance with at least one embodiment of the present invention.

FIG. 7 discloses examples of key encryption algorithms usable with at least one embodiment of the present invention.

FIG. 8A discloses a flowchart of an exemplary process for sending an encryption key in accordance with at least one embodiment of the present invention.

FIG. 8B discloses a flowchart of an exemplary process for receiving an encryption key in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

### I. Wireless Communication Device

As previously described, the present invention may be implemented using a variety of wireless communication equipment. Therefore, it is important to understand the communication tools available to a user before exploring the present invention. For example, in the case of a cellular telephone or other handheld wireless devices, the integrated data handling capabilities of the device play an important role in facilitating transactions between the transmitting and receiving devices.

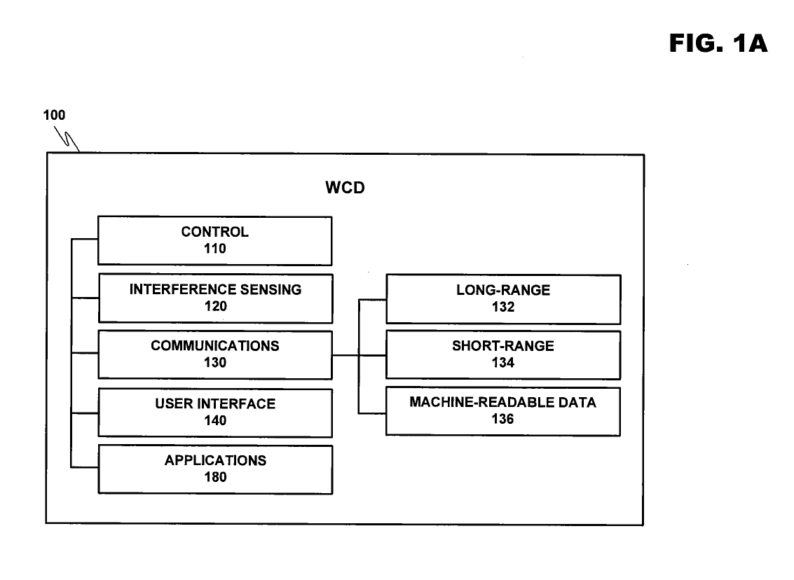

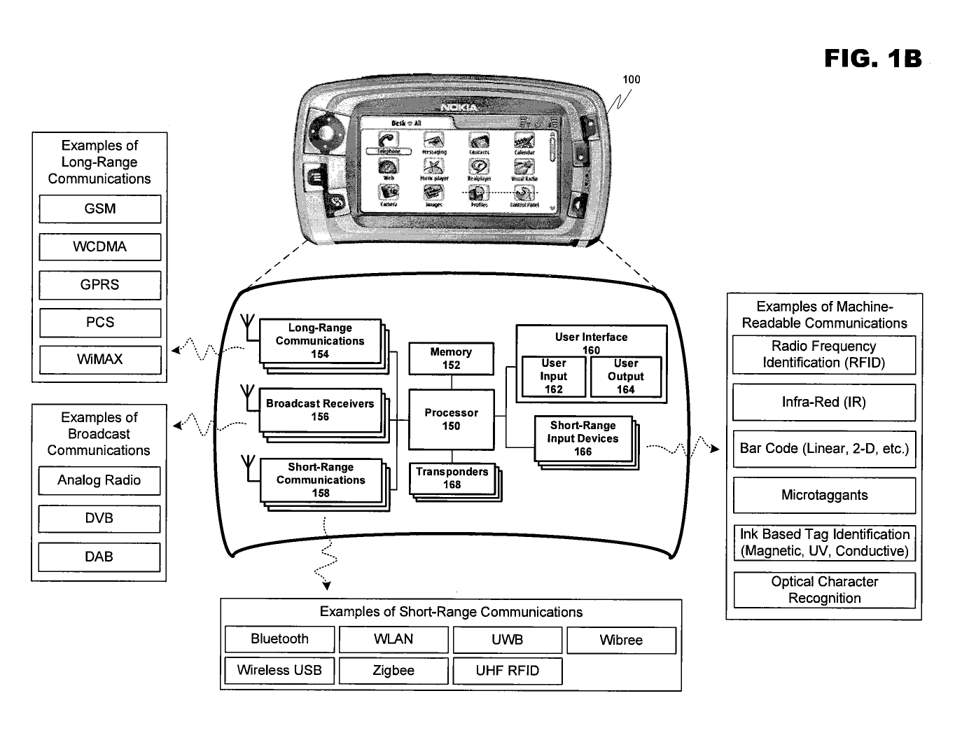

FIG. 1A discloses an exemplary modular layout for a wireless communication device usable with the present invention. WCD 100 is broken down into modules representing the functional aspects of the device. These functions may be performed by the various combinations of software and/or hardware components discussed below.

Control module 110 regulates the operation of the device. Inputs may be received from various other modules included within WCD 100. For example, interference sensing module 120 may use various techniques known in the art to sense sources of environmental interference within the effective transmission range of the wireless communication device. Control module 110 interprets these data inputs, and in response, may issue control commands to the other modules in WCD 100.

Communications module 130 incorporates all of the communication aspects of WCD 100. As shown in FIG. 1A, communications module 130 may include, for example, long-range communications module 132, short-range communications module 134 and machine-readable data module 136 (e.g., for NFC). Communications module 130 utilizes at least these sub-modules to receive a multitude of different types of communication from both local and long distance sources, and to transmit data to recipient devices within the transmission range of WCD 100. Communications module 130 may be triggered by control module 110, or by control resources local to the module responding to sensed messages, environmental influences and/or other devices in proximity to WCD 100.

User interface module 140 includes visual, audible and tactile elements which allow a user to receive data from, and enter data into, the device. The data entered by a user may be interpreted by control module 110 to affect the behavior of WCD 100. User-inputted data may also be transmitted by communications module 130 to other devices within effective transmission range. Other devices in transmission range may also send information to WCD 100 via communications module 130, and control module 110 may cause this information to be transferred to user interface module 140 for presentment to the user.

Applications module 180 incorporates all other hardware and/or software applications on WCD 100. These applications may include sensors, interfaces, utilities, interpreters, data applications, etc., and may be invoked by control module 110 to read information provided by the various modules and in turn supply information to requesting modules in WCD 100.

FIG. 1B discloses an exemplary structural layout of WCD 100 according to an embodiment of the present invention that may be used to implement the functionality of the modular system previously described in FIG. 1A. Processor 150 controls overall device operation. As shown in FIG. 1B, processor 150 is coupled to at least communications sections 154, 158 and 166. Processor 150 may be implemented with one or more microprocessors that are each capable of executing software instructions stored in memory 152.

Memory 152 may include random access memory (RAM), read only memory (ROM), and/or flash memory, and stores information in the form of data and software components (also referred to herein as modules). The data stored by memory 152 may be associated with particular software components. In addition, this data may be associated with databases, such as a bookmark database or a business database for scheduling, email, etc.

The software components stored by memory 152 include instructions that can be executed by processor 150. Various types of software components may be stored in memory 152. For instance, memory 152 may store software components that control the operation of communication sections 154, 158 and 166. Memory 152 may also store software components including a firewall, a service guide manager, a bookmark database, user interface manager, and any communication utilities modules required to support WCD 100.

Long-range communications 154 performs functions related to the exchange of information over large geographic areas (such as cellular networks) via an antenna. These long-range network technologies have commonly been divided by generations, starting in the late 1970s to early 1980s with first generation (1G) analog cellular telephones that provided baseline voice communication, to modem digital cellular telephones. GSM is an example of a widely employed 2G digital cellular network communicating in the 900 MHZ/1.8 GHZ bands in Europe and at 850 MHz and 1.9 GHZ in the United States. In addition to basic voice communication (e.g., via GSM), long-range communications 154 may operate to establish data communication sessions, such as General Packet Radio Service (GPRS) sessions and/or Universal Mobile Telecommunications System (UMTS) sessions. Also, long-range communications 154 may operate to transmit and receive messages, such as short messaging service (SMS) messages and/or multimedia messaging service (MMS) messages.

As a subset of long-range communications 154, or alternatively operating as an independent module separately connected to processor 150, transmission receiver 156 allows WCD 100 to receive transmission messages via mediums such as Digital Video Broadcast for Handheld Devices (DVB-H). These transmissions may be encoded so that only certain designated receiving devices may access the transmission content, and may contain text, audio or video information. In at least one example, WCD 100 may receive these transmissions and use information contained within the transmission signal to determine if the device is permitted to view the received content.

Short-range communications 158 is responsible for functions involving the exchange of information across short-range wireless networks. As described above and depicted in FIG. 1B, examples of such short-range communications 158 are not limited to Bluetooth™, Wibree™, WLAN, UWB and Wireless USB connections. Accordingly, short-range communications 158 performs functions related to the establishment of short-range connections, as well as processing related to the transmission and reception of information via such connections.

Short-range input device 166, also depicted in FIG. 1B, may provide functionality related to the short-range scanning of machine-readable data (e.g., for NFC). For example, processor 150 may control short-range input device 166 to generate RF signals for activating an RFID transponder, and may in turn control the reception of signals from an RFID transponder. Other short-range scanning methods for reading machine-readable data that may be supported by short-range input device 166 are not limited to IR communication, linear and 2-D (e.g., quick response or QR) bar code readers (including processes related to interpreting universal product codes or UPC labels), and optical character recognition devices for reading magnetic, Ultraviolet (UV), conductive or other types of coded data that may be provided in a tag using suitable ink. In order for short-range input device 166 to scan the aforementioned types of machine-readable data, the input device may include optical detectors, magnetic detectors, CCDs or other sensors known in the art for interpreting machine-readable information.

As further shown in FIG. 1B, user interface 160 is also coupled to processor 150. User interface 160 facilitates the exchange of information with a user. FIG. 1B shows that user interface 160 includes a user input 162 and a user output 164. User input 162 may include one or more components that allow a user to input information. Examples of such components include keypads, touch screens, and microphones. User output 164 allows a user to receive information from the device. Thus, user output portion 164 may include various components, such as a display, light emitting diodes (LED), tactile emitters and one or more audio speakers. Exemplary displays include liquid crystal displays (LCDs), and other video displays.

WCD 100 may also include one or more transponders 168. This is essentially a passive device that may be programmed by processor 150 with information to be delivered in response to a scan from an outside source. For example, an RFID reader mounted in an entryway may continuously emit radio frequency waves. When a person with a device containing transponder 168 walks through the door, the transponder is energized and may respond with information identifying the device, the person, etc. In addition, a reader may be mounted (e.g., as discussed above with regard to examples of short-range input device 166) in WCD 100 so that it can read information from other transponders in the vicinity.

Hardware corresponding to communications sections 154, 156, 158 and 166 provide for the transmission and reception of signals. Accordingly, these portions may include components (e.g., electronics) that perform functions, such as modulation, demodulation, amplification, and filtering. These portions may be locally controlled, or controlled by processor 150 in accordance with software communication components stored in memory 152.

The elements shown in FIG. 1B may be constituted and coupled according to various techniques in order to produce the functionality described in FIG. 1A. One such technique involves coupling separate hardware components corresponding to processor 150, communications sections 154, 156 and 158, memory 152, short-range input device 166, user interface 160, transponder 168, etc. through one or more bus interfaces (which may be wired or wireless bus interfaces). Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 160 may interact with a communication utilities software component, also contained in memory 152, which provides for the establishment of service sessions using long-range communications 154 and/or short-range communications 158. The communication utilities component may include various routines that allow the reception of services from remote devices according to mediums such as the Wireless Application Medium (WAP), Hypertext Markup Language (HTML) variants like Compact HTML (CHTML), etc.

### II. Wireless Communication Mediums

The present invention may be implemented with, but is not limited to, short-range wireless communication mediums. Bluetooth™ is an example of a short-range wireless technology quickly gaining acceptance in the marketplace. A Bluetooth™ enabled WCD may transmit and receives data, for example, at a rate of 720 Kbps within a range of 10 meters, and may transmit up to 100 meters with additional power boosting. Current systems may run at a nominal rate of 1 Mbps. A user does not actively instigate a Bluetooth™ network. Instead, a plurality of devices within operating range of each other will automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master, and wait for an active slot to become available. These devices continually switch between various active communication and power saving modes in order to transmit data to other piconet members. In addition to Bluetooth™ other popular short-range wireless networks include WLAN (of which “Wi-Fi” local access points communicating in accordance with the IEEE 802.11 standard, is an example), WUSB, UWB, ZigBee (802.15.4, 802.15.4a), Wibree™ and UHF RFID. All of these wireless mediums have features and advantages that make them appropriate for various applications.

Wibree™ is an open standard industry initiative extending local connectivity to small devices with technology that increases the growth potential in these market segments. Wibree™ technology may complement close range communication with Bluetooth™-like performance in the 0-10 m range with a data rate of 1 Mbps. Wibree™ is optimized for applications requiring extremely low power consumption, small size and low cost. Wibree™ may be implemented either as stand-alone chip or as Bluetooth™-Wibree™ dual-mode chip. More information can be found on the Wibree™ website: www.wibree.com.

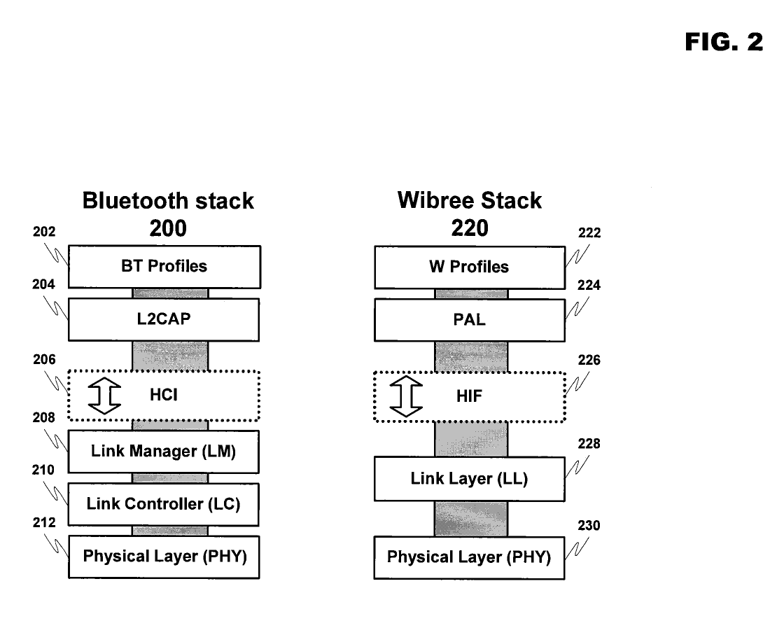

Now referring to FIG. 2, an exemplary Bluetooth™ protocol stack and an exemplary Wibree™ protocol stack are disclosed. Bluetooth™ stack 200 includes elements that may convey information from a system level to a physical layer where it may be transmitted wireless to another device. At the top level, BT Profiles 202 include at least a description of a known peripheral device which may be connected wirelessly to WCD 100, or an application that may utilize Bluetooth™ in order to engage in wireless communication with a peripheral device. The use of the phrase “peripheral devices” is not intended to limit the present invention, and is used only to represent any device external to WCD 100 also capable of wirelessly communicating with WCD 100. Bluetooth™ profiles of other devices may be established through a pairing procedure wherein identification and connection information for a peripheral device may be received by WCD 100 through a polling process and then saved in order to expedite the connection to the device at a later time. After the application and/or target peripheral device (or devices) is established, any information to be sent must be prepared for transmission. L2CAP level 204 includes at least a logical link controller and adaptation protocol. This protocol supports higher level protocol multiplexing packet segmentation and reassembly, and the conveying of quality of service information. The information prepared by L2CAP level 204 may then be passed to an application-optional host controller interface (HCI) 206. This layer may provide a command interface to the lower link manager protocol (LMP) layers, link manager (LM) 208 and link controller (LC) 210. LM 208 may establish the link setup, authentication, link configuration and other protocols related to establishing a wireless link between two or more devices. Further, LC 210 may manage active links between two or more devices by handling low-level baseband protocols. Wireless communication may then be established and conducted using the hardware (modem, antenna, etc.) making up physical layer (PHY) 212. Of course, the above identified layers of Bluetooth™ stack 200 may also be utilized in an order reversed from that disclosed above in order to receive a wireless transmission into WCD 100 from a peripheral device.

The layers in the standalone Wibree™ stack 220 are similar to the elements previously described. However, due to the relative simplicity of Wibree™ when compared to Bluetooth™, there are actually less layers utilized to achieve wireless communication. W Profiles 222, similar to the profiles used in Bluetooth™, are used to specify applications that may use Wibree™ for communication and peripheral devices with which a Wibree™ modem may wirelessly communicate. The profile adoption layer (PAL) 224 may be used to prepare the information for transmission via wireless communication. Host interface (HIF) layer 226 may provide an interface between the upper layers communicating with applications and schedulers in WCD 100, and the lower layers of the Wibree™ stack 220 which establish and maintain the links to peripheral devices. Lower layers of the Wibree™ stack 220 may further include at least link layer (LL) 228. LL 228 may both establish and maintain wireless communications with other wireless enabled devices through the use of Physical Layer (PHY) 230. Wibree™ LL 228, however, differs significantly from LM 208 and LC 210 in Bluetooth™.

### III. Dual-Mode Modem

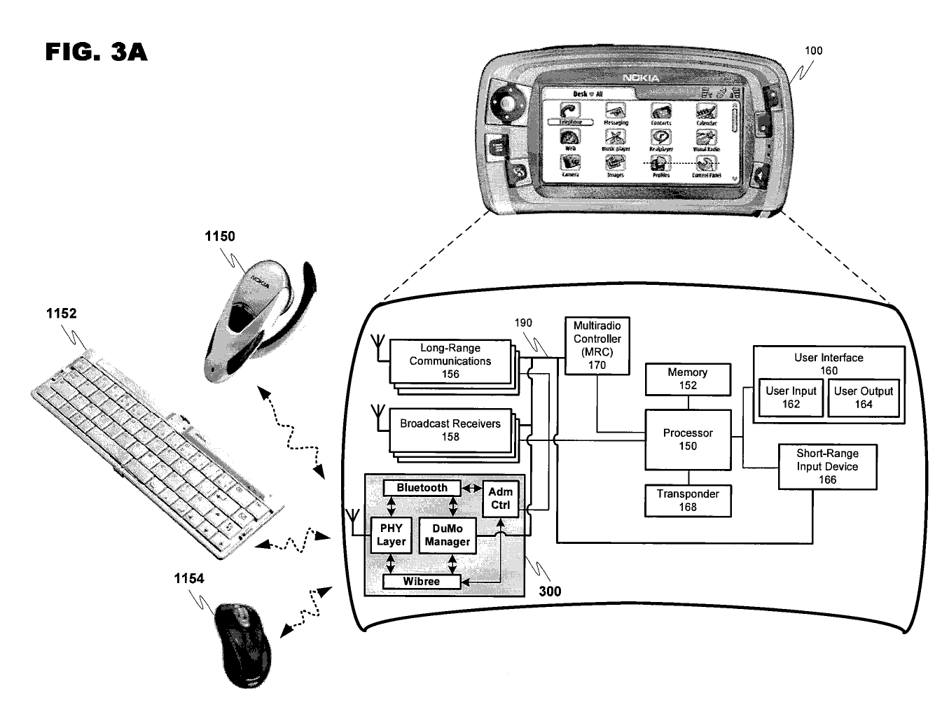

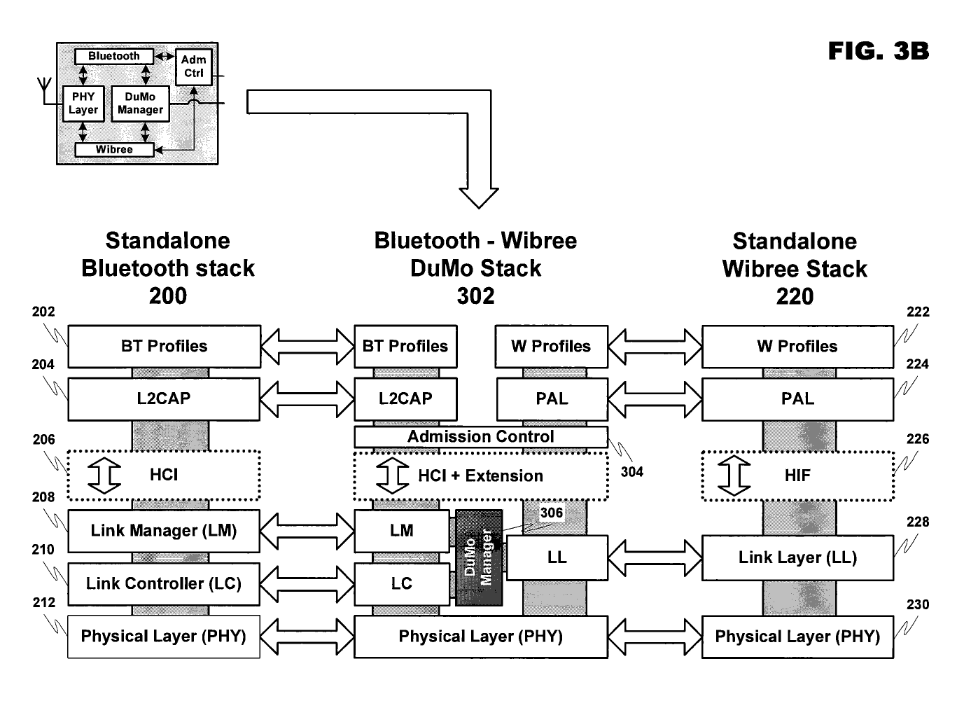

FIG. 3A includes an alternative exemplary implementation of at least one embodiment of the present invention. Again, in this example the three peripheral devices (1150, 1152 and 1154) are attempting concurrent communication with WCD 100 through dual-mode radio modem 300. Radio modem 300 may include local control resources for managing both “radios” (e.g., Bluetooth™ and Wibree™ software based radio control stacks) attempting to use the physical layer (PHY) resources of dual-mode radio modem 300. In this example, dual-mode radio modem 300 includes at least two radio stacks or radio protocols (labeled “Bluetooth” and “Wibree”) that may share the PHY layer resources (e.g., hardware resources, antenna, etc.) of dual-mode radio modem 300. The local control resources may include an admission controller (“Adm Ctrl”) and a dual-mode controller (“DuMo Manager”). These local control resources may be embodied as a software program and/or in a hardware form (e.g., logic device, gate array, MCM, ASIC, etc.) in a dual-mode radio modem interface, and the radio modem interface may be coupled to, or alternatively, embedded in dual-mode radio modem 300. The interaction of these control resources with the radio protocols utilizing dual-mode radio modem 300 is explained below.

With respect to FIG. 3B, an exemplary combination of the two separate radio protocol stacks (previously discussed with respect to FIG. 2) into a single combined entity controlled locally by at least an admission control 304 and a DuMo manager 306 is now disclosed. The two previously described standalone stacks are shown to establish the individual elements that may be incorporated into an integrated dual-mode entity 302. For a more specific discussion of the functioning of admission control 304 and a DuMo manager 306 in terms of managing the operations of dual-mode modem 300, please refer to application Ser. No. 11/538,310, filed Oct. 3, 2006, which is hereby incorporated by reference. Briefly, Admission control 304 may act as a gateway for the dual-mode radio modem 300 by filtering out both Bluetooth™ and Wibree™ requests from the operating system of WCD 100 that may result in conflicts. Scheduling information may also be provided by Multiradio controller (MRC) 170, wherein certain periods of operation are allocated to dual-mode radio modem 300 in view of the other active radio modems operating in WCD 100. This scheduling information may be passed down to both the HCI+Extension level of the combined protocol stacks and also to DuMo manager 306 for further processing. However, if scheduling information from MRC 170 is critical (delay-sensitive), it may be sent through MCS 190 via a direct connection to DuMo Manager 306. The information received by DuMo manager may 306 then be used to create an interleaved schedule for dual-mode radio modem 300 allowing both the Bluetooth™ and Wibree™ protocols to operate concurrently.

### IV. Protocol Stacks and Packet Routing

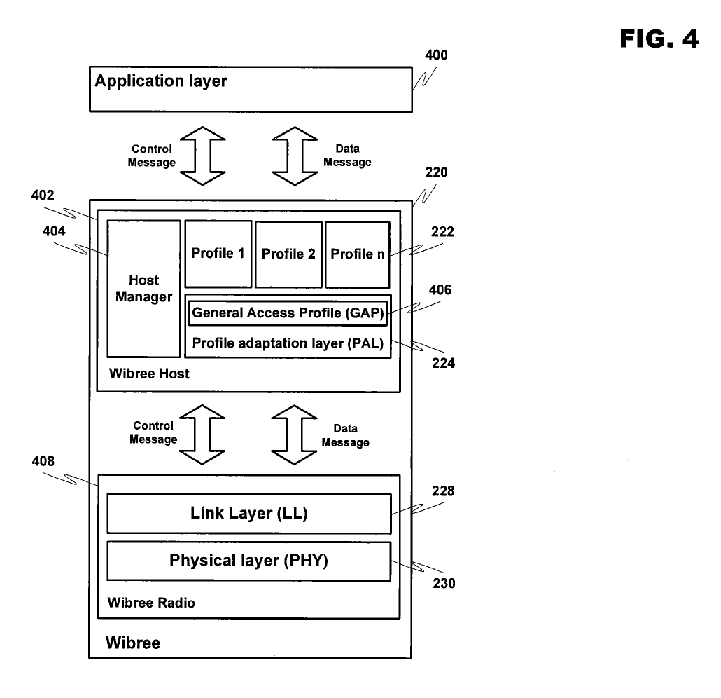

FIG. 4 includes a more detailed description of the upper layers of the Wibree™ communication protocol. The Wibree™ system includes two parts: the Wibree™ Radio 408 and the Wibree™ Host 402. Connection between radio 408 and host 402 goes through the HIF (Host Interface). Further, PAL 224 includes at least General Access Profile (GAP) 406.

Application layer 400 may include various programs that may be executed on a computing device. For example, an application may be a communication utility or productivity program running on a WCD. An application may use W Profiles 222 in Wibree™ (e.g. Profile 1, Profile 2, etc.) in order to send information into the Wibree™ protocol stack 220. This transaction may be supervised by Host Manager 404. The information may then be prepared by PAL 224 and GAP 406 for routing to Wibree™ radio 408, wherein LL 228 may both establish new wireless connections and manage existing connections with peripheral devices through the various resources (modem, antenna, etc.) that make up PHY layer 230.

### V. Security Encryption Methods

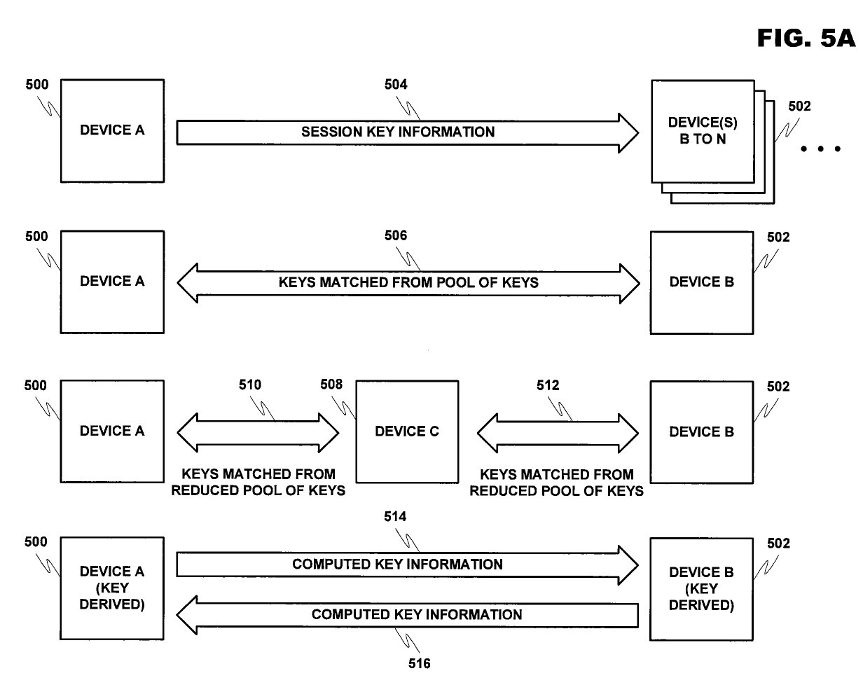

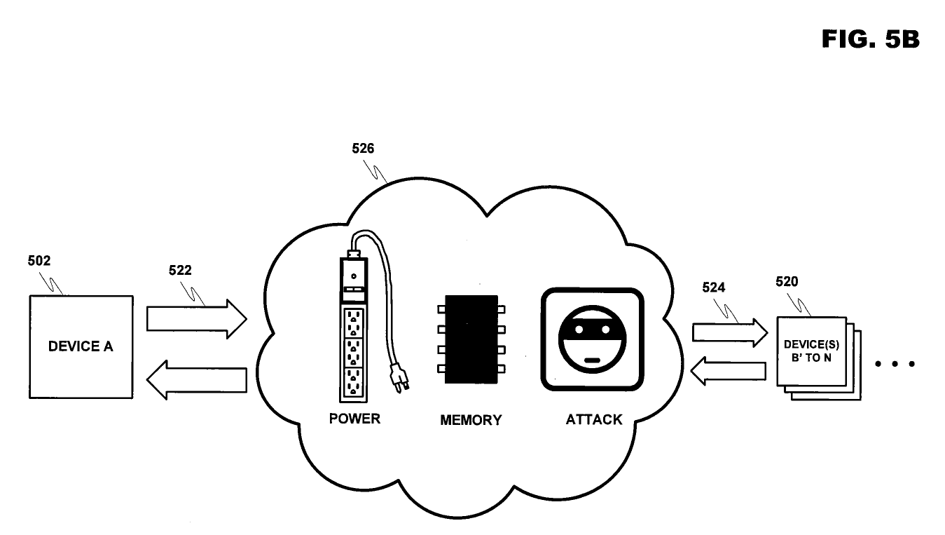

Now referring to FIG. 5, a number of exemplary key establishment algorithms are disclosed between at least two WCDs 500 and 502. Device A 502 may be, for example, WCD 100. A simple form of a key establishment algorithm is shown at 504. Here a session key is distributed to each device (devices B to N at 502) linking to device A 502. The same key is distributed to each device, allowing each device to identify other devices simply through the common session key. While this security theory may be simple, it lacks protection against third-parties wanting to gain access to the network. By compromising just one of the devices B to N 502, a third-party may obtain the session key and gain access to the network.

Another exemplary security strategy is shown at 506. In this security system, keys may be chosen from a large pool of keys values, and members of a wireless network may be determined by identifying themselves using keys from the pool of keys. Pair-wise shared keys requires storage of n keys, where n is at least the number of nodes in the network. This method may create a large overhead requirement in terms of configuration and memory consumption, since at deployment, only the keys for the neighbors would be used (e.g., four to five keys out of thousands of keys). The pair-wise key solution also provides no extensibility of the network exceeding the original intended maximum size (e.g., spanned by the pair-wise keys).

A modified version of the previously discussed key-pooling strategy is further shown at 508-512 in FIG. 5A. Some problems associated with a pre-distributed pools of keys were alleviated by probabilistic key sharing. A large key-space, for example 100,000 keys, is allocated, and each WCD is assigned a subset of keys. Therefore, device A 500 may have one set of keys which overlaps device C 508, which contains a second set, and device B 502 may contain a third set of keys that also has at least one key in common with device C 508. As these sets may overlap by at least one key, in some cases, device B 502 may communicate (as shown at 512 with device C 508) which shares a common key, and device C 508 may in turn convey information to device A 500 through transaction 510, since these devices share a common key.

In at least one scenario, if the assigned number of keys per device is 250, and the key space is again 100,000 keys, then there is a p=50% probability that two randomly selected WCDs may share at least one key. This p can be calculated by basic probability theory, but the creators of the key establishment strategy additionally refer to random graph theory to predict the probability as to whether a common key or “path” may exist between two nodes in the whole deployed network (in a graph), and also the case where no shared key exists between two (neighboring) devices. It can be shown that for large graphs that threshold function exists where the second probability (no shared keys between neighboring devices) moves from “nonexistent” to “certainly true” at some level of connectedness (pair-wise devices that do have common keys). Thus, even if two devices do not share a key, they can find a path over which every hop has a shared key in place, which may be rarely longer than a few hops. Probabilistic key-sharing has the advantage, that given a large key-space additional sensors can be deployed at a later time (the network can be extended). Also, in case a sensor is compromised, only a small set of keys may be revealed to the attacker.

The final example in FIG. 5A discloses a system such as the well-known Diffie-Hellman key establishment theory. In such a strategy, both devices may calculate encrypted keys based on an algorithm which may be interpreted by the other device in order to determine a common key value. For example, the protocol has two system parameters p and g. They are both public and may be used by all the users in a system. Parameter p is a prime number and parameter g (usually called a generator) is an integer less than p, with the following property: for every number n between 1 and p−1 inclusive, there is a power k of g such that n=g^{k} mod p. This relationship may be used by members of the network to determine a common k, which is the key.

While some of the aforementioned strategies may be easy to implement, for example in the case of a session key, or alternatively, may deliver strong encryption, they require resources that may not be available to low complexity and/or power constrained wireless devices. These limitations are now discussed with respect to FIG. 5B. Device 502, as previously disclosed, may be a device such as WCD 100. This device may communicate via wireless protocol 522, which for the sake of example may be a short-range wireless medium like Bluetooth™. Further, device(s) B′ to N 520 may be a low complexity and/or power constrained wireless device such as a sensor, an input device like a headset, etc. These device(s) may communicate, for example, via Wibree™ (shown in FIG. 5B as 524), an emerging wireless communication protocol with characteristics beneficial to devices such as B′ to N 520.

Initially, a few assumptions may be made about an exemplary user interface of low complexity and/or power constrained wireless devices. In some implementations there are no anticipated users (like in sensor networks), and even if a user interacts directly with the device, the interface may be limited to a few buttons and a couple of LEDs and/or “beeps” (consider, for example, wristwatches, mice, washing machines, MP3-players). The computing speed of the device is often minuscule compared to, for example, personal computers. If there is encryption on the communication channel the (symmetric) cipher suite is often implemented as a hardware solution, and its management is done with a simple, slow controller. Memory sizes of the controller can be in the single-digit kilobyte range for code, and possibly less that one kilobyte of data memory. There is often no global network support and no global connectivity. Thus, traditional internet-style key exchange and key distribution protocols based on, for example, trusted third parties (TTPs) may not be feasible to implement. Custom configuration during mass-production is expensive and time-consuming. Ideally, devices may leave the manufacturing line identically configured, and any configuration may be left up to the user to complete. The batteries of an exemplary device may be required to last for months without recharging.

Power consumption issues are in some cases the foremost design constraint. However, power is but one consideration in implementing a security strategy for exemplary situation depicted in FIG. 5B are shown at 526. Any computation will consume energy, and the resource requirements of security algorithms are typically significant compared to other logic needed for e.g. radio transmission. Dedicated chips/hardware blocks are more energy-efficient than running the same algorithm in a general purpose controller or processor. Also, in practice the complexity of even simple security algorithms cannot perform adequately in embedded controllers. Partly a subcategory of computation, the energy efficiency of memory (especially if it needs to be updated frequently) is, independently of technology, fairly low if compared to HW implementing simple logic flows. So a “memory-efficient” algorithm consumes less energy than a comparably complex algorithm that needs large intermediary storage buffers. Further, in terms of communication, the price of a transmitted bit is a dominant factor when it comes to energy consumption even for transmission distances in the sensor range (≦10 m). Thus, every saved bit in communication brings down the total energy cost.

Further, the susceptibility to attack is another consideration for low complexity and/or power constrained wireless devices. In simpler key encryption algorithms, attacks such as “man in the middle” (MITM) attacks may allow a third-party device to intercept sensitive or confidential information. A MITM attack occurs when a third-party device interposes itself between two other devices during key establishment. The two devices may believe that they are establishing a keyed relationship with each other, while in actuality they are establishing keyed relationships with the attacking third-party device. As a result, an attacker is able to read, insert and modify at will, messages between two parties without either party knowing that the link between them has been compromised. The attacker must be able to observe and intercept messages going between the two victims. To avoid this attack, a stronger algorithm should be employed, however, as previously explained, this is difficult to deploy on low complexity and/or power constrained wireless devices given the currently known key establishment strategies.

### VI. Combined Hardware Triggered and Software Encoded Method

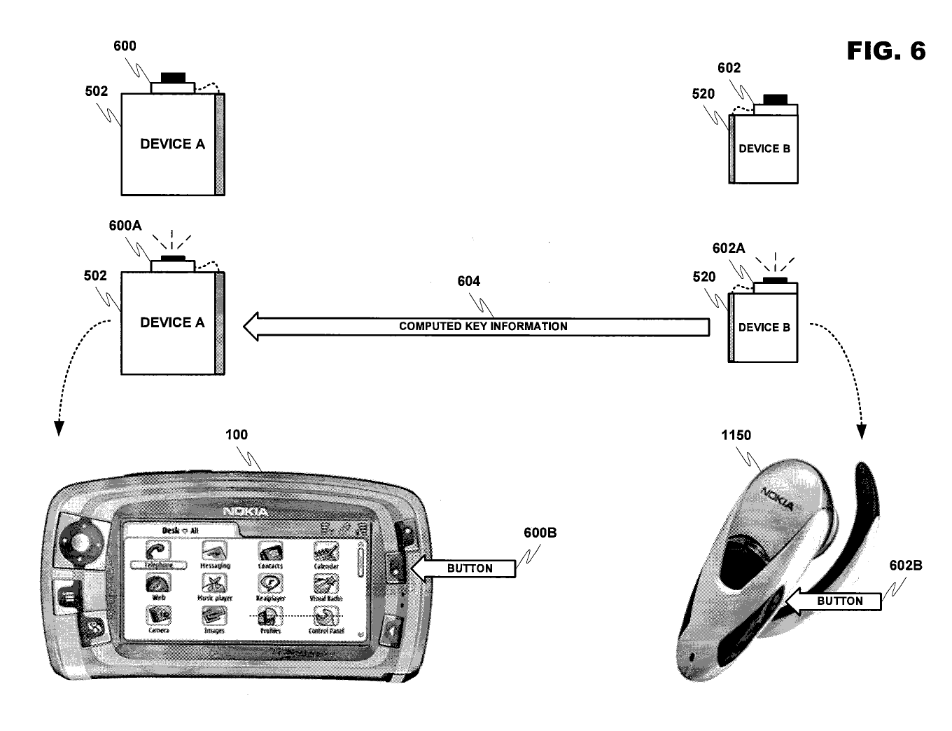

Consider an environment where devices come and go, and devices also might change their addresses at will (e.g. for privacy reasons). As a result, if the device periodically scans its environment there may be a lot of change occurring. An input mechanism on each of the devices may also be involved in the pairing. FIG. 6 discloses an example of inputs on devices 502 and 520. This input might constitute a single button (e.g. 600 and 602). The implementation of any button or key in FIG. 6 is for explanation purposes only, and should not be considered to limit the present invention. Any button or key on a wireless device may suffice, for example, the devices disclosed on the bottom of FIG. 6 (WCD 100 and headset 1150) have buttons indicated that may be used to implement the process of the present invention. The direction of the key establishment may be predetermined (e.g., one device is designated to transmit the key, the other device is designated to listen). The algorithm of the present invention may further be interleaved in a way where both devices send the key after alternating button presses or even, at the expense of security, in parallel (where no particular order is required).

The whole pairing process (which in at least one exemplary scenario could occur over a duration of hours) requires both devices to continually advertise random addresses changing at random intervals. Here, the choice is between a deployment strategy where the random address is changed very frequently, but within scanning resolution (so that an active scanner would with a very high probability catch all advertised addresses), or an adaptive strategy where the random address update is adjusted to the current volatility of the environment (e.g., sensed devices also transmitting within effective range of the devices 502 and 520). In the second case, the change of address also implies that the broadcasting of the new address need not follow immediately after the disappearance of the old, but rather this interval is also adjusted to environmental conditions. The basic difference between the strategies is that in the first instantiation the devices may strive to produce “false” information in order to confound a potential attacker with information, whereas the second strategy may hide the pairing in an already noisy environment, with the additional benefit of saving power. The latter strategy may operate at an advantage in public places, whereas the former strategy excels in secluded radio environments (like in homes).

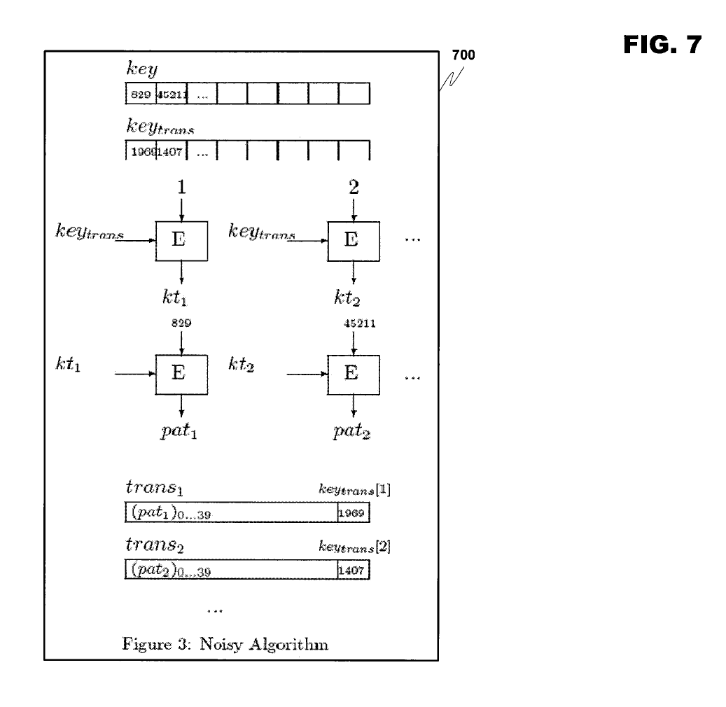

The actual key establishment may proceed as follows: The sending device 520 randomly generates two random keys: key and key_trans (for example 128 bits each), and then divides both keys into N (e.g., 16) subparts, each subpart being one byte in this example. The key_trans is diversified into 16 separate keys (see, for example, “FIG. 3: Noisy Algorithm in FIG. 7), and for each piece of the key, key[i], a pattern, patᵢ, is produced by encrypting with the diversified key. Key transmission packets may then be constructed by appending as much of patᵢ as possible to key_trans[i] to form the length of a standard address for the wireless protocol.

After the initialization phase, the key agreement/transfer may start. The user may be asked to press the buttons on both devices simultaneously (e.g., 600A and 602A in FIG. 6). When at least the key 602 is pressed on the sending device 602A, the device may change its own address to the relevant key transmission packet 604. The receiving device 502 may then record in its scan any new (not previously seen addresses) that appeared during a short interval (e.g., +/−3 seconds) initiated by the button press. This implies that the receiver should be continuously scanning during the pairing process, and maintain some form of FIFO queue of recently seen addresses. The user may then press one or both of the buttons N times, preferably over some interval and with variable intermission time. These events may be subliminal in the eyes of an observer on the radio alone. There may be no clear indication when a pairing starts and ends.

After the last button press (e.g., the button press sending the last subpart of the key), the receiving device should have collected a path (possibly even alternative paths) of devices that happened to transmit at the moment(s) designated by the key press. It is, however, preferable, that the devices continue to change addresses for a random period afterwards. From these paths, a number of alternative keys k of the counterpart can be retrieved. The received key subparts are tested against the addresses of the path, retrieving the xᵢ:s if a match is found in the addresses. The concatenations of the xᵢ:s subparts form the key.

The present system in at least one embodiment of the present invention may also lend itself to password initiation. For example, a 4-digit PIN can be labeled using visual indicia on the sending device (e.g., headset 1150). The PIN may be transformed (by any pseudo-random generator) into a timed sequence of N events. The timing need not be more exact that in the range seconds to an hour. On entry into WCD 100, the same sequence may be initiated, and the process may include an unpaired headset starting the pairing at boot-up. A user may be asked to synchronize to the headset, possibly by entering the PIN into WCD 100 (replacing key presses). However, the resolution of the PIN should not be allowed to affect the resolution of the timing.

This algorithm is not energy-efficient, in fact in its first instantiation it may be wasting energy to provide obfuscation, and through that, security. It is, however, cost-efficient in the presence of symmetric encryption (or keyed hash) hardware, the key establishment logic is nearly trivial and easy to implement. Hurrying through the scheme may make an attack significantly easier. The instructions in a mobile scenario may read, for example: “Start the pairing, and keep the devices close to each other in a pocket, handbag or equivalent. Go for a coffee break or the ride the bus to work, and now and then retrieve the devices and press the buttons simultaneously. You'll have to press the buttons 16 times (a beep will sound when you press the buttons the 16th time). Take your time, the longer the duration, the better the security.”

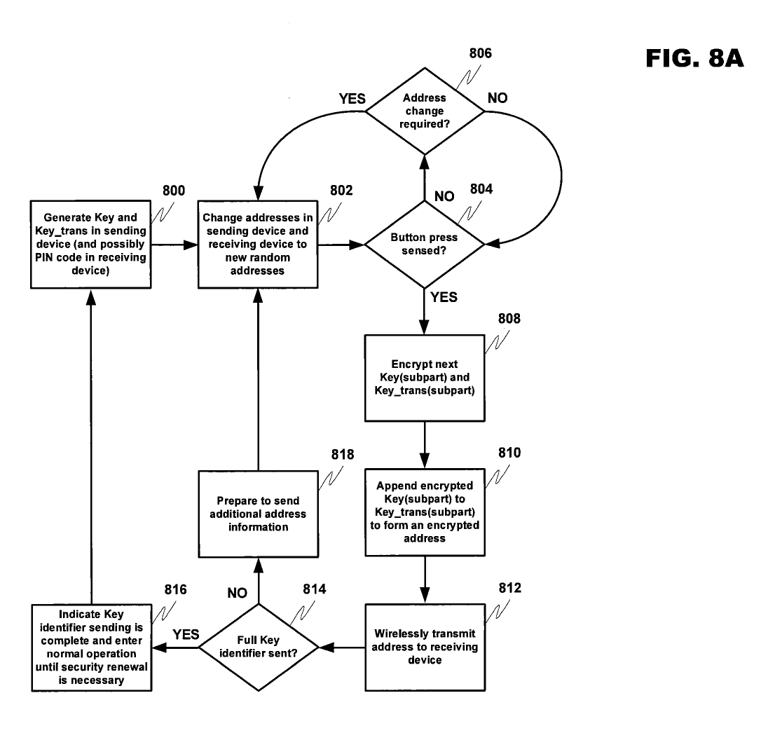

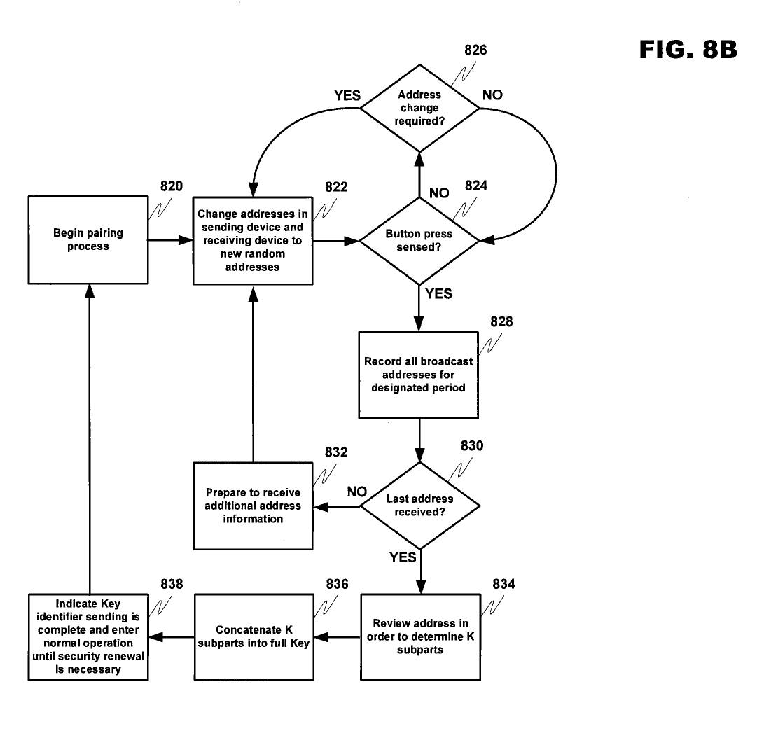

FIG. 8A presents and exemplary process for a sending device in accordance with at least one embodiment of the present invention. In step 800 a Key and a Key_trans keys are generated in the sending device. This generation may be based on a PIN hard-coded into the sending device (as previously disclosed). The sending device must continually and randomly change its address value in order to confound any third-party devices trying to attack the wireless network by intercepting information. In step 802 this random address change may occur. The sending device further senses for a button or key press in step 804. If there is no key press then a check is made in step 806 to determine if it is time to reset the address of the sending device. If not then the check for a button or key press continues. Otherwise the address is reset in step 802.

If a key press is detected in step 804, then in step 808 at least one subpart of one or both of the Key and Key_trans are encoded. At least one subpart of the Key_trans is appended to one or more subparts of the Key-trans to form a device address (step 810), and this address is then broadcast in step 812. In step 814 a query is made to determine if additional subparts are left to transmit. If there are additional subparts to transmit, then the process prepares to transmit additional subparts in step 818 and then the process renews at step 802. Otherwise, an indication may be given that the process is complete in step 816, and the sending device enters a normal operation mode until security renewal may be required.

In FIG. 8B the process in the receiving device begins at step 820. Blocks 822-826 are similar to the sending device, wherein the receiving device will randomly change its address to defeat third-party devices that might be attempting to infiltrate the network. This “obfuscation” is essential for the pairing process to be secure. Because of these address changes (conveying random data that, in principle, could be a key-part packet) we significantly increase the workload of the attacker—without these the workload of the attacker is equivalent to that of the receiver. If a key press is detected in step 824, the process moves to step 828 wherein the receiving device records all broadcast addresses for a designated period of time. If this button press is not the last button press to complete the key (step 830, possibly indicated as part of the information received from the sending device) then the receiving device prepares for additional button presses/address accruals in step 832, which returns to step 822 to restart the part of the process awaiting the next key press. If this address collection is the last button press expected, then in step 834 the receiving device begins to decode the received addresses in order to recover the subparts of the Key.

In step 836 the subparts of the key may be concatenated in order to form a complete key usable for security and authentication purposes in the wireless network. In this process, the possible subpart will form a graph (a lattice) that essentially describes the possible key set (e.g., combinations of possible key parts). In an ideal case this would be a straight line with one address per time slot (and one choice of key). Given the lattice, the receiving device must attempt all possible combinations, which is where the patterns come into play. The correct key will match the patterns that is part of the “key-part packet”, in the instantiation described, for every possible key_trans the receiver must for a given pattern (e.g., pat1) loop through the possible key part values (255 variations) and see if the end result matches the pat1. If so, the key is found with a high probability, but the receiver can also verify this with, for example, pat2.

This may be a lot of work if the lattice is big, but consider the case for the adversary with no time windows to rely on, and if the pairing devices change their addresses (“fake key parts”) at will in between the time windows the adversary will, in a sense, have a huge number of nodes in his lattice, the point being that the problem quickly explodes in a way (like chess moves on a checkerboard) where the computational effort to try all combinations of the attackers lattice in any realistic timeframe may become too high. After the recompilation process is completed, indication may be given that the process is complete in step 836, and the receiving device enters a normal operation mode until security renewal may be required.

In a further embodiment, time synchronization is arranged by signaling at the beginning of the pairing. The timed events are collected in the endpoints without any intermediate signaling. In a further embodiment, the key is formed not by transmitted key parts, but by a function of a concatenation of chosen timeslot identifiers (e.g., in a TDD or TDMA system) and other information (such as the device identifiers, random nonces exchanged, etc.).

A possible ambiguity in a formed key can be resolved by negotiation afterwards, for example, by the endpoints acknowledging whether a given timed event was in the beginning or end of the discrete timeslot, and some state-of-the-art key confirmation scheme. This can serve as the way to construct the short PIN on devices that do not have a keypad (e.g., 5 button presses in 10 possible time slots would be equivalent to a 4-digit passkey).

The present invention provides, in at least one embodiment, a key establishment security system for low complexity and/or power constrained wireless devices communicating over a wireless protocol. The key establishment may provide strong security protection while not overwhelming simple devices with complex algorithms. The randomness added to the keying process by requiring manual intervention by the user further helps to confound possible attacks from third-parties.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method for secure wireless communication, comprising:
generating key information and transmission key information;
dividing the key information and the transmission key information into subparts;
generating pattern information based on encrypting each subpart of the key information using the transmission key information;
combining at least one subpart of the pattern information with one or more subparts of the encrypted transmission key information to form address information; and
exposing, as a result of sequentially timed events, the address information via wireless communication.

2. The method of claim 1, wherein generating key information and transmission key information includes taking into account predetermined PIN number information known to both the sending device and the receiving device.

3. The method of claim 2, wherein the PIN information is hard-coded in the sending device and manually entered in the receiving device.

4. The method of claim 1, wherein the sequentially timed events are button presses on one or both of a sending device and a receiving device.

5. The method of claim 4, wherein the sending device and the receiving device randomly change their addresses between each key press.

6. The method of claim 4, wherein the key press occurs in both the sending device and the receiving device, and each key press occurs substantially simultaneously.

7. The method of claim 1, wherein an indicator on one or both of the sending device and the receiving device indicates when all of the key information has been received.

8. The method of claim 1, wherein a receiving device decrypts and recombines the subparts of the key information received from the sending device.

9. A computer program product comprising a computer usable medium having computer readable program code embodied in said medium for secure wireless communication, comprising:
a computer readable program code for generating key information and transmission key information;
a computer readable program code for dividing the key information and the transmission key information into subparts;
a computer readable program code for generating pattern information based on encrypting each subpart of the key information using the transmission key information;
a computer readable program code for combining at least one subpart of the pattern information with one or more subparts of the encrypted transmission key information to form address information; and
a computer readable program code for exposing, as a result of sequentially timed events, the address information via wireless communication.

10. The computer program product of claim 9, wherein generating key information and transmission key information includes taking into account predetermined PIN number information known to both the sending device and the receiving device.

11. The computer program product of claim 10, wherein the PIN information is hard-coded in the sending device and manually entered in the receiving device.

12. The computer program product of claim 9, wherein the sequentially timed events are button presses on one or both of a sending device and a receiving device.

13. The computer program product of claim 12, wherein the sending device and the receiving device randomly change their addresses between each key press.

14. The computer program product of claim 12, wherein the key press occurs in both the sending device and the receiving device, and each key press occurs substantially simultaneously.

15. The computer program product of claim 9, wherein an indicator on one or both of the sending device and the receiving device indicates when all of the key information has been received.

16. The computer program product of claim 9, wherein a receiving device decrypts and recombines the subparts of the key information received from the sending device.

17. A wireless communication device, comprising:
at least one processor enabled to perform method steps including:
generating key information and transmission key information;
dividing the key information and the transmission key information into subparts;
generating pattern information based on encrypting each subpart of the key information using the transmission key information;
combining at least one subpart of the pattern information with one or more subparts of the encrypted transmission key information to form address information; and
exposing, as a result of sequentially timed events, the address information via wireless communication.

18. The device of claim 17, wherein the device further includes a transmitter and receiver for communicating via Wibree™ communication.

19. The device of claim 17, wherein the device is power constrained.

20. A method for secure wireless communication, comprising:
receiving, as a result of sequentially timed events, address information from other devices via wireless communication;
decrypting the received address information using received pattern information in order to determine which addresses include key subparts; and
combining the subparts of key information in order to form a key.

21. The method of claim 20, wherein the sequentially timed events are button presses on one or both of a sending device and a receiving device.

22. The method of claim 20, wherein the key information includes PIN number information known to both the sending device and the receiving device.

23. A computer program product comprising a computer usable medium having computer readable program code embodied in said medium for secure wireless communication, comprising:
a computer readable program code for receiving, as a result of sequentially timed events, address information from other devices via wireless communication;
a computer readable program code for decrypting the received address information using received pattern information in order to determine which addresses include key subparts; and
a computer readable program code for combining the subparts of key information in order to form a key.

24. The computer program product of claim 23, wherein the sequentially timed events are button presses on one or both of a sending device and a receiving device.

25. The computer program product of claim 23, wherein the key information includes PIN number information known to both the sending device and the receiving device.

26. A wireless communication device, comprising:
at least one processor enabled to perform method steps including:
receiving, as a result of sequentially timed events, address information from other devices via wireless communication;
decrypting the received address information using received pattern information in order to determine which addresses include key subparts; and
combining the subparts of key information in order to form a key.

27. The device of claim 26, wherein the device further includes a transmitter and receiver for communicating via Wibree™ communication.

28. The device of claim 26, wherein the device is power constrained.

29. A chipset, comprising:
a processing unit enabled to perform method steps including:
generating key information and transmission key information;
dividing the key information and the transmission key information into subparts;
generating pattern information based on encrypting each subpart of the key information using the transmission key information;
combining at least one subpart of the pattern information with one or more subparts of the encrypted transmission key information to form address information; and
exposing, as a result of sequentially timed events, the address information via wireless communication.

30. The chipset of claim 29, further comprising a receiver for receiving the sequentially timed events in the form of electrical triggers.

31. A chipset, comprising:
a processing unit enabled to perform method steps including:
receiving, as a result of sequentially timed events, address information from other devices via wireless communication;
decrypting the received address information using received pattern information in order to determine which addresses include key subparts; and
combining the subparts of key information in order to form a key.

32. The chipset of claim 31, further comprising a receiver for receiving the sequentially timed events in the form of electrical triggers.

33. A transmitter, comprising:
a processing unit enabled to perform the method steps including:
generating key information and transmission key information;
dividing the key information and the transmission key information into subparts;
generating pattern information based on encrypting each subpart of the key information using the transmission key information;
combining at least one subpart of the pattern information with one or more subparts of the encrypted transmission key information to form address information; and
exposing, as a result of sequentially timed events, the address information via wireless communication.

34. A receiver, comprising:
a processing unit enabled to perform the method steps including:
receiving, as a result of sequentially timed events, address information from other devices via wireless communication;
decrypting the received address information using received pattern information in order to determine which addresses include key subparts; and
combining the subparts of key information in order to form a key.

35. A wireless communication device, comprising:
means for generating key information and transmission key information;
means for dividing the key information and the transmission key information into subparts;
means for generating pattern information based on encrypting each subpart of the key information using the transmission key information;
means for combining at least one subpart of the pattern information with one or more subparts of the encrypted transmission key information to form address information; and
means for exposing, as a result of sequentially timed events, the address information via wireless communication.

36. A wireless communication device, comprising:
means for receiving, as a result of sequentially timed events, address information from other devices via wireless communication;
means for decrypting the received address information using received pattern information in order to determine which addresses include key subparts; and
means for combining the subparts of key information in order to form a key.
